(19) United States
(12) Patent Application Publication
(10) Pub. No.: US 2009/0165139 A1
(43) Pub. Date: Jun. 25, 2009

(54) Secure Computer System and Method

(76) Inventors: William S. Yerazunis, Acton, MA (US); Joseph Langeway, Wolcott, CT (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/962,818

(22) Filed: Dec. 21, 2007

(51) Int. Cl. G06F 21/02

(52) U.S. Cl. 726/26

(57) ABSTRACT

An apparatus is configured to perform secure processing of confidential information. The apparatus comprises a secure disk configured to store confidential information arranged inside a lockable container; a processor configured to process the confidential information arranged inside the lockable container; an insecure network arranged outside the lockable container; and means for connecting the processor only to the secure disk or alternatively to the insecure network at any one time, but not to both the secure disk and the insecure network at the same time.

### FIELD OF THE INVENTION

This invention relates generally to secure computing, and more particularly to allowing users secure access to confidential information in an insecure environment and with untrustworthy software.

### FIELD OF THE INVENTION

The issue of security in computing has been of concern since the mid-1960's. The need for computer security is described in the U.S. Department of Defense “Trusted Computer System Evaluation Criteria,” also known as “the Orange Book.” Even though the Orange Book has been superseded by the Common Criteria, formally the ISO/IEC 15408 standard, it is still commonly used because it is more understandable than the ISO document.

However the Orange Book and the Common Criteria are both based on the needs of multi-user systems where multiple users doing multiple tasks share a common processor and data storage system, with protection assisted by hardware. This was taken to one extreme in the Multics project, Elliot Organick, “The Multics System: Δn Examination of its Structure,” ISBN 0-262-15012-3, 1972. In the Multics system, an ownership of each piece of data in the system is ascribed, and an access control list (ACL) of acceptable accessors, whether read-only or read/write, etc., is generated. The hardware then assists in preventing unauthorized access to data. Unfortunately, the proper maintenance of the ACL continues to be a problem. Work to improve ACL maintenance is described in U.S. Pat. No. 7,178,164 by Bonnes.

Physical security of the computer itself is another issue. Anderson et al. in U.S. Pat. No. 4,600,249 describe one method of physical security in the form of a lockable cabinet with distressed-thread nuts to prevent removal of the cabinet without first opening the cabinet to access both the bolt head and nut, and several means to allow access to removable computer readable media without permitting theft of the removable media.

Another computer security technique is the “Virtual Machine” technique pioneered in the late 1960s by IBM in the original 360 model 67, and extended in the IBM products such as CP-67, VM-370, and in current IBM offering, the Z-series. In that method of security, each user is given a “virtual machine,” and the system hardware prevents access to any user user's data by any other user. Allowing cross-user data transfer is automatically prohibited by hardware unless overridden by a user with the appropriate system management credentials.

However, the context of computing is changing. For applications that do not need the high performance of mainframe systems, such as a Z-series computer, the most common computer is the PC using operating systems such as Windows, MacOS, or Linux. In the first two cases, the systems are essentially single-user; in the third, multi-user mode is supported for server use.

The cost of these PC systems is a fraction of the mainframe systems they replaced, and provide the same level of performance, albeit to only one user at a time. The cost of these systems is continuously decreasing due to the economics of mass production and the ability to produce millions of processors chips for a very low cost.

As a disadvantage of this context change is that while a mainframe system usually has a multi-person fulltime staff to provide maintenance and security updates, a single-user personal computer only has the user, who may not be experienced in terms of system management and system security. Therefore, overall system maintenance and application of security updates may not be prompt, or even done at all, for fear of loss of some functionality.

The desire to have operating systems and utilities with a lot of functionality, coupled with the desire of software companies to maximize revenues by directing users to the preferred web sites, has led to a proliferation of systems that are insecure. The time required to download the latest security patches is much longer than the average time for a virus to infect a system. Therefore, keeping such systems secure is problematic at best.

Some users, such as those at the very highest level of national security, have required absolute isolation of the secure computer from the Internet. For example, computers processing certain government-classified information must not have a network connection to an insecure network, sometimes called the “red” network. I may also be prohibited to leave the computer unattended with media containing either the confidential information or executable programs. Typically, those computers are powered up only when the users are physically present, and when the users leave, the computer is powered down and the computer readable media are removed and placed in a locked safe. Such computers may or may not be networked, but only to a secure non-public-accessible network, sometimes called the “blue” network, with a strong prohibition on any interconnection of the red (insecure) and blue (secure) networks. At one extreme, entire buildings are designated either “red” or “blue” and only the corresponding type of network is permitted to operate in the building.

A disadvantage of those secure computing systems is that if a program takes more than a workday to complete, the program must be “checkpointed” at intermediate times so that the program can be restarted later. Systems, such as servers for national-security processing tasks that are running twenty-four hours a day, must also be attended continuously. Such conditions are extremely expensive and not cost-effective for commercial and non-national-security confidential data such as medical, employment, salary, financial, and judiciary information, which are often required by law to be secured against “hacking”, as in the Health Insurance Portability & Accountability Act of 1996 (HIPAA, Title II).

### SUMMARY OF THE INVENTION

The embodiments of the invention provide a method and system for processing confidential information securely in an insecure environment, or with untrustworthy software. Specifically, the invention enables an authorized user to access confidential information in an environment that is only semi-secure, while allowing processing to continue in the absence of the user. Further, the invention allows the secure system to be updated via a network with possibly hostile software, and yet retain desired secure computing properties.

### BRIEF DESCRIPTION OF THE DRAWINGS

FIG. 1 is a block diagram of a secure computer according to an embodiment of the invention;

FIG. 2 is a schematic of connections to the secure computer of FIG. 1;

FIG. 3 is a block diagram of a secure computer system according to another embodiment of the invention; and

FIG. 4 is a state diagram for the secure computer according to an embodiment of the invention.

### DETAILED DESCRIPTION OF THE EMBODIMENTS OF THE INVENTION

The embodiments of our invention provide a secure computer system and processing method by means of a combination of physical security and mechanical interlocks. A physical secure environment, i.e., a safe, prevents physical access to confidential information by unauthorized personnel. Mechanical interlocks, such as multi-pole switches with non-return mechanisms, or distancing rods, are used to physically prohibit a concurrent connection to an insecure network and secure computer readable media storing the confidential information.

An object of our invention is to also allow the use of the secure computer system with an insecure network, to load updates to software and to download programs, without compromising in any way the security of the confidential information.

Another object of our invention is to allow long-term program execution of non-trusted programs, without the need for continuous supervision. The computer system can be secured when the user leaves without disrupting the work flow. Processing can be resumed with almost no overhead, while the computer system is in an electronically and physically secured state, and optionally with programs that may take days or even weeks to complete running uninterrupted.

To do this, we provide a mechanical interlock that allows the user to easily select between “system is connected to network” and “system is connected to confidential information” without the possibility of accidentally connecting to both at the same time.

Secure Computer System

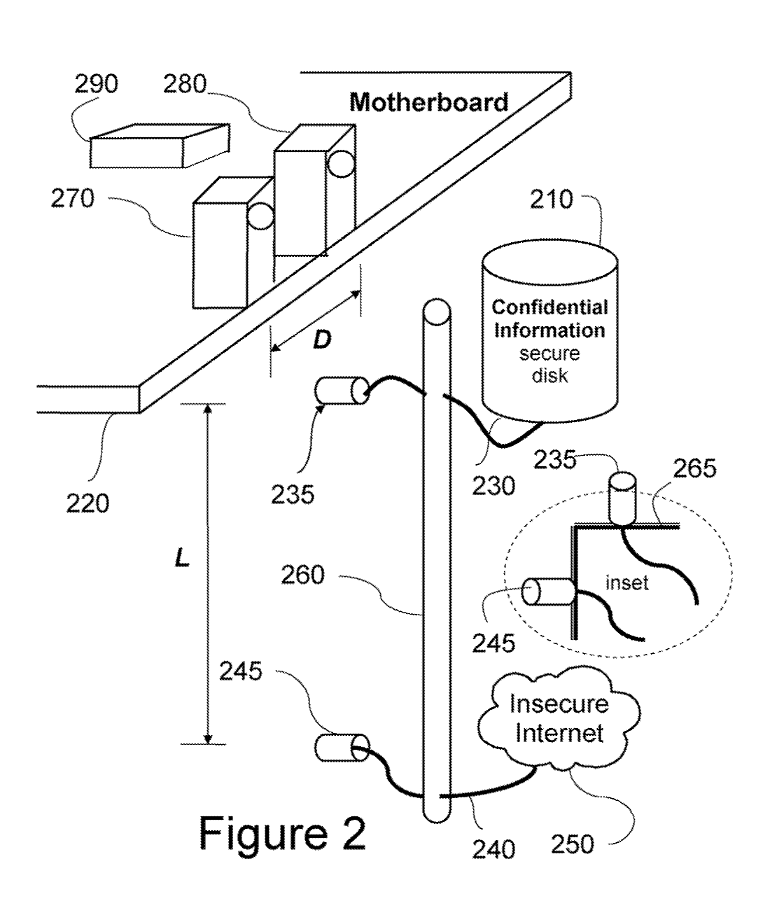

FIG. 2 shows the basic components of our secure computer system. A universal system bus (USB) connector 235 is used to interface a secure disk 210 storing confidential information (CI) to a conventional motherboard 220 of a computer via a USB cable 230. Typically, the motherboard includes a processor 290.

A network cable 240 is used to attach to the insecure Internet 250. Ends of the network cable 240 with end connector 245 and confidential information USB data cable 230 with end connector 235 are attached to a rigid member, e.g., a rod 260.

A length of the rod does not allow both cables to be connected concurrently to a (first) disk port 280 and a (second) network port 270 on the motherboard 220 of the computer system. It should be understood that the ports can be Ethernet, USB or other similar ports as are typically used in PCs to connect the motherboard (and the processor to devices and networks. It is understood that a connection can include intermediate components such as disk and network controllers, and computer busses.

In other words, the length L of a portion of the rod where the connectors 235 and 245 are attached is different than the distance D between the ports 270 and 280.

This arrangement works especially well on commonly available commercial motherboards, where the ports are typically within a few centimeters of each other. In this case, a ten centimeter long rod with the cables attached with only one or two centimeters of slack at each end suffices to mechanically guarantee that when the secure disk 210 is connected and accessible, the insecure network 250 must be disconnected and inaccessible, and vice versa.

This mechanical isolation is assured as long as the length L is either greater than the motherboard port distance D plus the slack in the USB disk cable, plus the slack in the network cable, or if the length of the motherboard plug distance D is greater than the rod length L plus the USB cable slack plus the slack in the networking cable. Alternatively, rigid angular member or bracket 265 can be used instead of length, see inset. The bracket that holds the USB connector and network connector at orientations such that only one connector can be plugged into the motherboard ports at a time to also satisfy the mechanical isolation requirement.

This arrangement is adequate for some applications, but it is actually secure only when the software running on the computer is “trusted” not to copy the data on the secure disk 210 to any other connected disk, such as a temporary directory or paging file on the system disk.

For example, the untrustworthy software is a text editor. Temporary working copies of information being edited are sometimes automatically written to a paging file, as well as backup and recovery copies written to other directories. Information which may be confidential may also be stored in a registry. Typically, these temporary copies are not “cleaned up” completely, or at all, should the system crash. Thus, when the network is reconnected at some point in the future, unauthorized persons could possibly access the information from the paging file or the temporary directory on the system disk via the network connection. It is even possible to leak information by having a document remain “open” and in system RAM when the rod and cable arrangement is switched from “confidential information” to “network accessible.”

To prevent this kind of unauthorized access, we guarantee that even untrustworthy software never is given the opportunity to access the secure disk 210. Because this includes the (insecure) hard drive where the operating system is stored, the system RAM, and the video RAM, all of these components must either be forcibly cleared of all data, such as by turning the power off and then on again, or made unwritable, such as with the write-protect wire, before the secure disk is connected to the processor via the motherboard port.

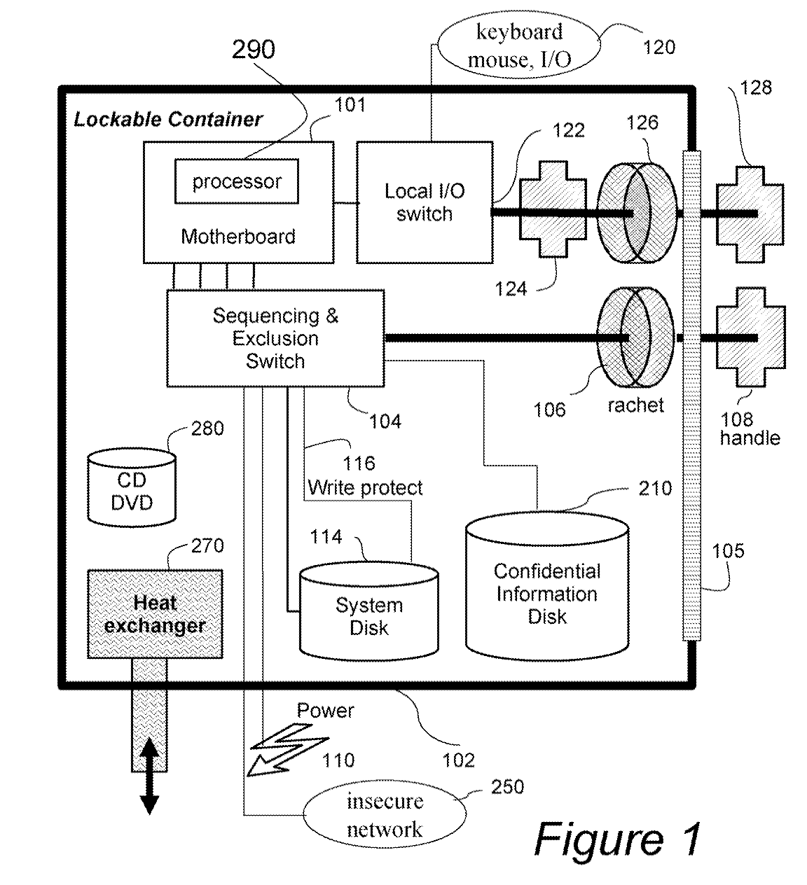

FIG. 1 shows an embodiment of our secure computer system. A conventional CPU motherboard 220 is arranged inside a lockable container 102, e.g., a safe. We replace the rod-and-two-cables arrangement with a multi-position, multi-circuit mechanical switch 104, called the sequencing and exclusion switch. This sequencing and exclusion switch includes a ratchet 106, so that the switch can be moved through a series of positions but only in a predetermined sequence. The ratchet can include a clutch mechanism to connect with a handle 108, which can extend through the door 105 of the safe. The handle 108 is arranged outside the safe.

The handle can only move the switch one step forward with each motion of the handle 108. For a rotary switch, a set of positions for the switch 104 that satisfies a secure sequencing requirement is:

### 1. Power off

2. Power on, no connection to the insecure network and the secure disk
3. Power on, insecure network connected
4. Power on, no connection to the insecure network and the secure disk
5. Power on, insecure disk write protected
6. Power on, insecure disk write protected, secure disk connected
7. Power on, insecure disk write protected, secure disk disconnected,
8. and back to position 1 to repeat.

The ratchet 106 prevents operation of the switch in a reverse direction. The handle can only move the switch one step forward in the sequence. An improvement to this arrangement adds two or more power-off positions to guarantee that power is off (unconnected and memory cleared) by insuring that the handle 108 must be operated repeatedly to connect to the power 110 on, thereby imposing an adequate time delay for the power supply capacitors to be fully drained and volatile data is erased, before the power is reconnected.

The switch 104 can be implemented as a multi-pole rotary switch, or as a set of switches operated by a mechanical arrangement, or even as a set of electromechanical or electronic relays that open and close circuits, or that force the signals on appropriate wires to either logic 0 or logic 1, indicating on and off, or unconnected and connected. In this case, the handle may not be required. In any case, the switch is can be operated from outside the safe.

Typically, the computer is ‘booted’ by operating the handle 108 to position 2 or 3, so that power 110 is connected, and that the insecure (red) network 250 is connected. In this state, the system is powered up with a network connection so software can be downloaded and system updates can be performed. In this state, insecure programs can access the insecure network. There is no protection against untrusted software, e.g., a virus. However, because the confidential information disk 210 is not connected, there is no possibility of accessing the confidential information.

Then, to access the confidential information, the handle 108 is actuated. Actuating to position 4 disconnects the insecure network 250. Actuating to position 5 then write-protects the insecure disk 114, e.g., the system hard drive, by asserting the hardware write-protection wire 116, which means that even if untrusted software is running, no confidential data can be written to the insecure disk 114.

Actuating to position 6 then connects the secure disk 210 and the computer user can now perform any work desired, using the secure disk 210 for both the confidential information, and for storing any temporary files needed, but only on the secure disk 210.

Actuating switch 104 to position 7 disconnects the secure disk 210, and one last actuation completes the cycle back to position 1, disconnecting power 110. The final power off state is required to insure that no accessible confidential information remains in any volatile memories, such as system RAM or video RAM, which are dependably erased during a power off.

This guarantees a secure system and method of dealing with the confidential information. The switch 204 prevents accidental release of confidential information even when the computer is running untrustworthy, or even subject to intentionally malicious programs.

The steps above are listed as single steps for clarity. However, several of the steps can be combined. For example, positions 2 and 3 (power 110 connected, and power 110 connected with network 250 connected) can be combined. Similarly, positions 4 and 5 (no insecure network 250 and no secure disk 210, and the insecure disk write protection 116 activated) can be combined.

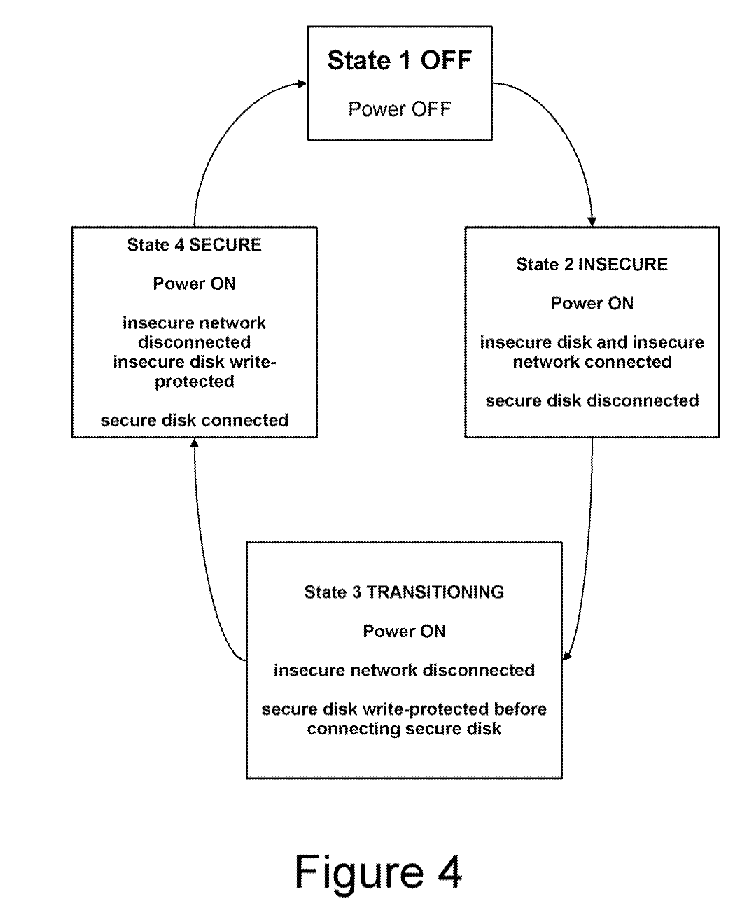

As shown in FIG. 4, four states are required to guarantee security. These states must occur in a strict sequential and circular order.

State 1. POWER OFF 401: the system is powered off, no processing or IO action can occur

State 2 INSECURE 402: The system is powered on; the insecure disk is connected for read and write access, the insecure network is connected, but the secure CI disk is disconnected from the processor.

State 3 TRANSITIONING 403: Power stays on, but the insecure network is disconnected and the insecure disk is write-protected before the secure CI disk is connected. This can be accomplished either by a stable state allowing no network connection, a write-protected insecure disk, and no connection to the CI data disk, or by a transient state created by the use of a “break before make” switch that mechanically disconnects one set of electrical contacts before connecting other electrical contacts. A break-before-make switch assures that there is no way a partial motion of the controlling handle can allow either simultaneous access to the insecure network and the secure CI disk, or simultaneous write access to the insecure disk and the secure CI disk.

State 4 SECURE 404: The system is powered on, the insecure network is disconnected, the insecure disk is write-protected, and the secure CI disk is connected and accessible.

The next state after the SECURE state is back to the OFF state. This minimal set of four states guarantees security.

To assist the user in recognizing the current security state of the computer system, the current position of the switch can be displayed oil a mechanical indicator such as a rotating disc or drum, or on a digital display.

A second issue is maintaining the local physical security of the computer, while the user is not present, if an untrusted person attempts to use the computer without authorization through local I/O devices 120, such as a display device, keyboard, and mouse, and USB jacks.

It is desirable to be able to set local I/O devices to a secured configuration. Therefore, we provide a second “I/O” switch 122 to control the connections between the I/O devices and the motherboard 220.

In the first position of I/O switch 122, the motherboard is connected to both the mouse/keyboard (either through the standard PS/2 connectors or with USB keyboards and mice) and to the display device. In the second position, the keyboard and mouse are disconnected, but the display device remains connected, so the computer can display only the information that a previously started program has generated. In this switch position, it is not possible to start or stop currently executing programs or alter the execution of the already-executing programs. In the third position the display device is also disconnected and the motherboard is “running by itself” and cannot be controlled or monitored from the keyboard, mouse, or display.

The I/O switch 122 is similarly actuated by a handle 128 and ratchet 126, so that the switch can be moved from the “all connected” position to the “display only” connected position, and then to the “no connections” position from outside the safe by the handle 128 via a slip clutch and ratchet 126.

However, unlike the secure switch 104, this switch cannot be reset to the first position by further actuations. Repeated actuations after reaching the “no connections” position leave the switch in the “no connections” position. Instead, resetting the switch to a less-secure position requires that the safe be opened (or an equivalent combination, passcode, or key-lock be actuated) and the use of an inside handle 124. This reset to an in secure configuration can also be triggerable by operating the switch 104 through the ‘Power Off’ (# 1) position. If the switch 104 is enabled to reset the “I/O” switch, then an unauthorized person could use the keyboard and display device to view the confidential information, but not to access the information. If the “I/O” switch 122 is not reset by the ratchet switch, then no matter what the unauthorized person does, the confidential data remains secure.

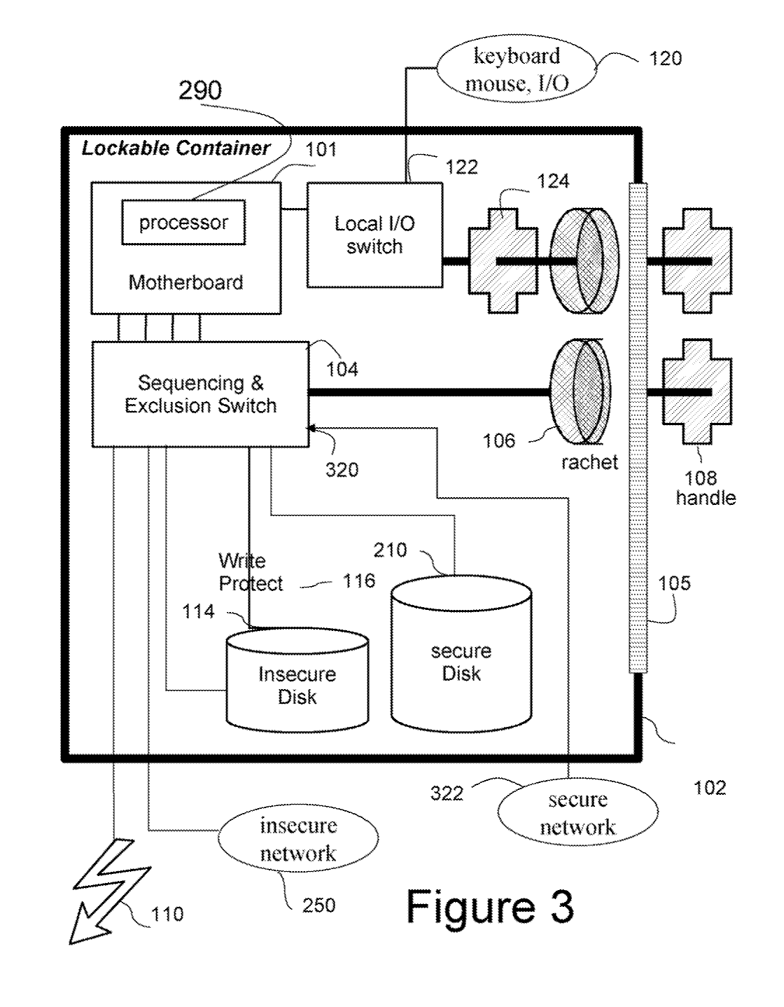

Another embodiment of the secure system is shown in FIG. 3. In this embodiment, the sequencing and exclusion switch 104 is also connected to a second network port 320. This second network port 320 provides access to a secure network 322 that has no connection to any computer except through the switch 104 in those computers. The second network port 320 is connected to the secure network 322 only at the same switch positions as the secure disk 210 is connected.

The lockable container 102, ratchet 106, handle 108, hardware write protect wire 116 disk 312, secure disk 210, connection to power 110 and the insecure network 250 are as before. The secure network 322 can include servers that store the CI information, individual protected computers do not need a local CI disk but can use a network-attached CI disk via a network file protocol on the secure network.

For even better assurance that the secure network 322 is always isolated from the insecure network 250, we can use nonstandard connectors or a re-pinning of standard connectors oil the secure network 322. For example, four of the eight pins in a standard RJ45 Ethernet cable are unused, and are often unconnected; if the secure network uses those pins (and only those pins) then the secure network (storing the confidential information) cannot accidentally be connected to the insecure network. For even better security, a totally different type of connector, such as a Molex connector, can be used instead of a standard RJ45 network connector. The Molex connector is a two-piece “pin and socket” interconnection, frequently used for connecting disk drives.

It should be noted that in situations where persons who have physical access to the computer system are trustworthy, and the physical security of the site is adequate, the switch 104, by itself, is still useful because it prevents the accidental transmission of confidential data by a careless user or a compromised application program.

It should also be noted that some systems default to using a “paging” or “swap” file. If these are turned on (and by default they usually are) and if they are located on the insecure disk (as they usually are), then when the secure disk is write protected in position 5, the swapping and paging functions of the operating system will fail. This will not cause CI data to be compromised so security is maintained, but it may cause a system hang when the switch 104 is in any position where the system disk becomes write protected. This can be corrected by turning paging and swapping “off” with a system configuration setup utility.

One issue with operating a system in a locked safe for long periods of time is that safes typically have very poor heat transfer characteristics and no ventilation whatsoever. Without ventilation or other cooling, the temperature in the safe can increase until the system either fails or an over-temperature sensor forces an overheat shutdown. Further, operating the disks at elevated temperatures shortens the life of these components.

For this reason, one embodiment of the invention includes an active water cooling system arranged inside the safe. For this task, commercially available “water cooled CPU and video chip” systems are inadequate because they cool only the CPU and video chips. Other large, heat-producing chips in the system, as well as the memory, the hard drives, and the power supply are not cooled and cause the temperature inside the safe to increase.

Therefore, in one preferred embodiment an inside-the-safe heat exchanger 270 is provided.

The secure computer may also need a CD/DVD drive to load the programs, to run backups, and to generate computer-readable outputs for authorized users. For this reason, one embodiment includes a CD/DVD disk 290 inside the safe. The security for the CD/DVD drive can be ensured as described above.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. An apparatus configured to perform secure processing of confidential information, comprising:
a secure disk configured to store confidential information arranged inside a lockable container;
a processor configured to process the confidential information arranged inside the lockable container;
an insecure network arranged outside the lockable container; and
means for connecting the processor only to the secure disk or alternatively to the insecure network at any one time, but not to both the secure disk and the insecure network at the same time.

2. The apparatus of claim 1, in which the processor is arranged on a motherboard, and further comprising:
a first port arranged on the motherboard for connecting the processor to the secure disk;
a second port arranged on the motherboard for connecting the processor to the insecure network;
a first connector and cable for connecting the secure disk to the first port;
a second connector and cable for connecting the insecure network to the second port; and in which the means for connecting further comprises:
a rigid rod physically connected to the first and second connectors and cables such that a length of a portion of the rigid rod between the first connector and the second connector is different than a distance between the first port and the second port.

3. The apparatus of claim 1, in which the means for connecting is a sequencing and exclusion switch having a plurality of positions, in which the plurality of positions comprise:
a first position for power off;
a second position for power on, no connection to the insecure network and the secure disk;
a third position for power on, insecure network connected;
a fourth position for power on, no connection to the insecure network and the secure disk;
a fifth position for power on, insecure disk write protected;
a sixth position for power on, insecure disk write protected, secure disk connected; and
a seventh position for insecure disk write protected, secure disk disconnected; and further comprising:
means for sequencing through the plurality of positions only in a forward order.

4. The apparatus of claim 3, in which the sequencing and exclusion switch is a in multi-position, multi-circuit mechanical switch including a ratchet.

5. The apparatus of claim 3, in which the switch is connected to a handle for operating the switch, and in which the handle is arranged outside the lockable container.

6. The apparatus of claim 3, in which the sequencing and exclusion switch is a rotary switch.

7. The apparatus of claim 3, in which the switch imposes a delay between power off and power on to ensure erasure of volatile data.

8. The apparatus of claim 3, in which the switch includes electrical relays.

9. The apparatus of claim 1, further comprising:
an insecure disk; and
means for write-protecting the insecure disk when the secure disk is connected to the processor.

10. The apparatus of claim 3, further comprising:
means for displaying the plurality of position of the switch.

11. The apparatus of claim 1, further comprising:
a plurality of I/O ports arranged on the motherboard for connecting the processor to a plurality of I/O devices; and
an I/O switch for selectively connecting the processor to the I/O devices.

12. The apparatus of claim 1, further comprising:
a secure network arranged outside the lockable container; and
means for connecting the processor to the secure network only when the insecure network is disconnected from the processor.

13. The apparatus of claim 1, further comprising:
a heat exchanger arranged inside the lockable container.

14. The apparatus of claim 1, in which the means for connected is operatable from outside the lockable container when the lockable container is locked.

15. The apparatus of claim 1 in which the processor is arranged on the motherboard, and further comprising:
a first port arranged on the motherboard for connecting the processor to the secure disk;
a second port arranged on the motherboard for connecting the processor to the insecure network;
a first connector and cable for connecting the secure disk to the first port;
a second connector and cable for connecting the insecure network to the second port; and in which the means for connecting further comprises:
a rigid member holding the two connectors such that it is impossible to connect both connectors to both ports simultaneously.

16. The apparatus of claim 15, in which the rigid member is angular such that the two connectors have different orientations.

17. The apparatus of claim 15, in which the rigid member is a rod such a length of a portion of the rigid rod between the first connector and the second connector is different than a distance between the first port and the second port.

18. The apparatus of claim 1, further comprising:
an insecure disk arranged inside the lockable container, and in which there are four states which must occur in a strict sequential and circular order, comprising:
a first state when power is off;
a second state when the power is on and the processor is connected to the insecure disk and the insecure network, and the secure disk is disconnected from the processor;
a third state when the power is on and the insecure network is disconnected and the insecure disk is write-protected before the secure disk is connected to the processor; and
a fourth state when the power is on and the insecure network is disconnected and the insecure disk is write-protected, and the secure disk is connected.

19. A method for performing secure processing of confidential information, comprising the steps of:
storing confidential information on a secure disk arranged inside a lockable container;
processing the confidential information by a processor arranged inside the lockable container; and
connecting the processor only to the secure disk or alternatively to an insecure network at any one time, but not to both the secure disk and the insecure network at the same time.

20. The method of claim 19, further comprising:
arranging an insecure disk arranged inside the lockable container, and in which there are four states which must occur in a strict sequential and circular order, comprising:
a first state when power is off;
a second state when the power is on and the processor is connected to the insecure disk and the insecure network, and the secure disk is disconnected from the processor;
a third state when the power is on and the insecure network is disconnected and the insecure disk is write-protected before the secure disk is connected to the processor; and
a fourth state when the power is on and the insecure network is disconnected and the insecure disk is write-protected, and the secure disk is connected.
